(19) United States
(12) Patent Application Publication
(10) Pub. No.: US 2025/0155575 A1
(43) Pub. Date: May 15, 2025

(54) OPTICAL DEVICE AND RANGING DEVICE

(71) Applicant: SONY SEMICONDUCTOR SOLUTIONS CORPORATION, Kanagawa (JP)

(72) Inventor: Fumihiko HANZAWA, Kanagawa (JP)

(73) Assignee: SONY SEMICONDUCTOR SOLUTIONS CORPORATION, Kanagawa (JP)

(21) Appl. No.: 18/839,197

(22) PCT Filed: Feb. 17, 2023
(86) PCT No.: PCT/JP2023/005795

§ 371 Date: Aug. 16, 2024

(30) Foreign Application Priority Data
Feb. 25, 2022 (JP) 2022-028044

(51) Int. Cl. G01S 17/89; G01S 7/481

(52) U.S. Cl. CPC G01S 17/89; G01S 7/4814; G01S 7/4816

(57) ABSTRACT

An optical device is downsized. An optical device includes a light source unit, a first lens, a second lens, a light receiving element, and a light guide portion. The light source unit emits emission light. The first lens emits the emission light. The second lens projects, onto an object, the emission light emitted by the first lens and emits reflected light obtained by reflection of the projected emission light on the object. The light receiving element receives the reflected light emitted by the second lens. While guiding, to the second lens, the emission light emitted by the first lens, the light guide portion guides the reflected light emitted by the second lens and emits the reflected light to the light receiving element in a direction substantially parallel to the emission light emitted by the first lens.

### FIELD

The present disclosure relates to an optical device and a ranging device.

### BACKGROUND

A ranging device that measures a distance to an object by a time of flight (ToF) method is used. This ranging device is a device that measures a distance to an object by emitting light to the object, receiving reflected light reflected by the object, and measuring time of flight of the light. As such a ranging device, for example, a ranging system that includes a light projecting unit to project emission light and a light receiving unit to receive reflected light from an object, and measures a time from projection of the emission light to reception of the reflected light has been proposed (see, for example, Patent Literature 1).

This ranging system performs ranging of a wide visual field area by projecting emission light and receiving reflected light through a common optical path. Specifically, the emission light is projected through a wide-angle lens that is a common optical path, and the reflected light is received through the wide-angle lens. A beam splitter is arranged adjacent to the wide-angle lens. The beam splitter causes an optical path to branch into an optical path that guides the emission light to the wide-angle lens and an optical path that guides the reflected light from the wide-angle lens. The beam splitter causes the optical paths of the emission light and the reflected light to branch in directions different from each other by 90 degrees.

### CITATION LIST

### Patent Literature

Patent Literature 1: Japanese Patent Application Laid-open No. 2020-153798

### SUMMARY

### Technical Problem

However, in the above-described conventional technique, since the emission light and the reflected light are caused to branch, there is a problem that the light projecting unit and the light receiving unit are arranged at distant positions. Thus, in the above-described conventional technique, there is a problem that the device is increased in size.

Thus, the present disclosure proposes an optical device and a ranging device with which the devices are downsized.

### Solution to Problem

An optical device according to the present disclosure includes: a light source unit that emits emission light; a first lens that emits the emission light; a second lens that projects the emission light, which is emitted by the first lens, onto an object and emits reflected light obtained by reflection of the projected emission light on the object; a light receiving element that receives the reflected light emitted by the second lens; and a light guide portion that guides and emits the reflected light, which is emitted by the second lens, to the light receiving element while guiding, to the second lens, the emission light emitted by the first lens, wherein the light guide portion emits the reflected light in a direction substantially parallel to the emission light emitted by the first lens.

A ranging device according to the present disclosure includes: a light source unit that emits emission light; a first lens that emits the emission light; a second lens that projects the emission light, which is emitted by the first lens, onto an object and emits reflected light obtained by reflection of the projected emission light on the object; a light receiving element that receives the reflected light emitted by the second lens; a light guide portion that guides and emits the reflected light, which is emitted by the second lens, to the light receiving element while guiding, to the second lens, the emission light emitted by the first lens; and a ranging unit that measures a distance to the object on a basis of an image signal generated by the light receiving element on a basis of the reflected light, wherein the light guide portion emits the reflected light in a direction substantially parallel to the emission light emitted by the first lens.

### BRIEF DESCRIPTION OF DRAWINGS

FIG. 1 is a view illustrating a configuration example of a ranging device according to an embodiment of the present disclosure.

FIG. 2 is a view illustrating a configuration example of an optical device according to a first embodiment of the present disclosure.

FIG. 3 is a view illustrating a configuration example of a light source unit according to the first embodiment of the present disclosure.

FIG. 4 is a view illustrating an example of a ranging method according to the first embodiment of the present disclosure.

FIG. 5 is a view illustrating another configuration example of the optical device according to the first embodiment of the present disclosure.

FIG. 6 is a view illustrating a configuration example of an optical device according to a second embodiment of the present disclosure.

FIG. 7 is a view illustrating a configuration example of a light source unit according to the second embodiment of the present disclosure.

FIG. 8 is a view illustrating a configuration example of an optical device according to a third embodiment of the present disclosure.

FIG. 9 is a view illustrating an example of a ranging method according to the third embodiment of the present disclosure.

FIG. 10 is a view illustrating a configuration example of an optical device according to a fourth embodiment of the present disclosure.

FIG. 11 is a view illustrating a configuration example of an emission light polarization direction changing portion and a reflected light polarization direction changing portion according to the fourth embodiment of the present disclosure.

FIG. 12 is a view illustrating a configuration example of an optical device according to a fifth embodiment of the present disclosure.

FIG. 13 is a view illustrating a configuration example of an optical device according to a modification example of the embodiment of the present disclosure.

FIG. 14 is a view illustrating a configuration example of a light source driving unit according to the embodiment of the present disclosure.

FIG. 15 is a view illustrating a configuration example of a light source unit according to the embodiment of the present disclosure.

FIG. 16 is a block diagram illustrating a configuration example of a light receiving element.

### DESCRIPTION OF EMBODIMENTS

In the following, embodiments of the present disclosure will be described in detail on the basis of the drawings. The description will be made in the following order. Note that in each of the following embodiments, overlapped description is omitted by assignment of the same reference sign to the same parts.
1. First embodiment
2. Second embodiment
3. Third embodiment
4. Fourth embodiment
5. Fifth embodiment
6. Modification example
7. Configuration example of a light source driving unit and a light source unit
8. Configuration example of a light receiving element

### 1. First Embodiment

### Configuration of a Ranging Device

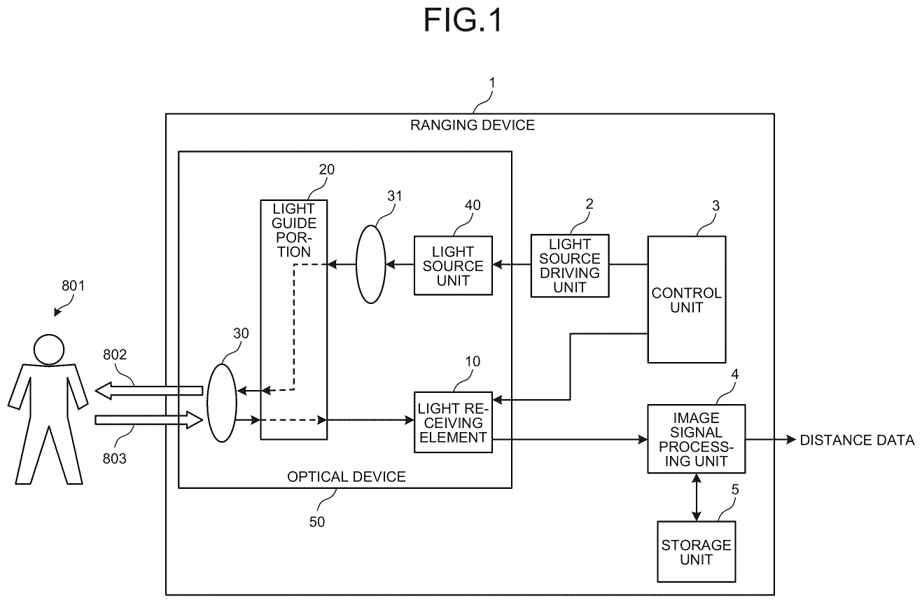

FIG. 1 is a view illustrating a configuration example of a ranging device according to an embodiment of the present disclosure. The drawing is a block diagram illustrating a configuration example of a ranging device 1. The ranging device 1 is a device that measures a distance to an object. The ranging device 1 in the drawing emits emission light 802 to an object 801, and receives reflected light 803 reflected by the object 801. At that time, a distance to the object 801 can be measured by measurement of time of flight that is time from the emission of the emission light 802 to the reception of the reflected light 803.

The ranging device 1 includes an optical device 50, a light source driving unit 2, a control unit 3, an image signal processing unit 4, and a storage unit 5. The optical device 50 includes a light source unit (light source unit 40) and a light receiving element (light receiving element 10), and performs the emission of the emission light 802 and the reception of the reflected light 803. The light source driving unit 2 drives the light source unit 40 of the optical device 50. The control unit 3 controls the light source driving unit 2, and the light receiving element 10 of the optical device 50. The image signal processing unit 4 processes a signal (image signal) output from the light receiving element 10. The image signal processing unit 4 detects a distance to the object 801 from the image signal output from the light receiving element 10, and outputs the distance as distance data. The storage unit 5 holds data and the like of processing in the image signal processing unit 4.

The optical device 50 includes the light source unit 40, a first lens 31, a light guide portion 20, a second lens 30, and the light receiving element 10.

The light source unit 40 emits emission light. The light source unit 40 includes, for example, a light source such as a laser diode, emits light under control of the light source driving unit 2, and emits the light as emission light. Details of the configuration of the light source unit 40 will be described later.

The first lens 31 is a light source lens, and is a lens that emits emission light emitted from the light source unit 40. The first lens 31 emits the emission light emitted from the light source unit 40 as substantially parallel light, for example. The emission light substantially collimated by the first lens 31 enters the light guide portion 20.

The second lens 30 is an intermediate image lens, and is a lens that projects the emission light substantially collimated by the first lens 31 onto the object and emits reflected light. The second lens 30 in the drawing represents an example of a case where the emission light is emitted as substantially parallel light. In addition, the second lens 30 in the drawing emits the emission light and projects the light onto the object through a light projecting/receiving optical system 80. As illustrated in the drawing, the second lens 30 configures a common optical path of emission light 802 and reflected light 803.

While guiding the emission light substantially collimated by the first lens 31 to the second lens 30, the light guide portion 20 guides and emits reflected light substantially collimated by the second lens 30 to the light receiving element 10. Note that the light guide portion 20 guides the reflected light in a direction substantially parallel to the emission light emitted by the second lens 30. A dotted arrow in the drawing indicates a state of guiding the emission light and the reflected light in the light guide portion 20. Details of the configuration of the light guide portion 20 will be described later.

The light receiving element 10 receives the reflected light substantially collimated by the second lens 30. The light receiving element 10 includes pixels (pixels 100 described later) each of which has a photoelectric conversion unit to perform photoelectric conversion and which are arranged in a two-dimensional matrix shape. A photodiode formed on a semiconductor substrate can be applied to the photoelectric conversion unit. Each of the pixels 100 generates an image signal on the basis of the received reflected light. Furthermore, the pixel 100 outputs the generated image signal to the image signal processing unit 4. As described later, the light receiving element 10 is arranged adjacent to the light source unit 40. Details of the configuration of the light receiving element 10 will be described later. Note that the light receiving element 10 is an example of a light receiving unit described in claims.

### Configuration of an Optical Device

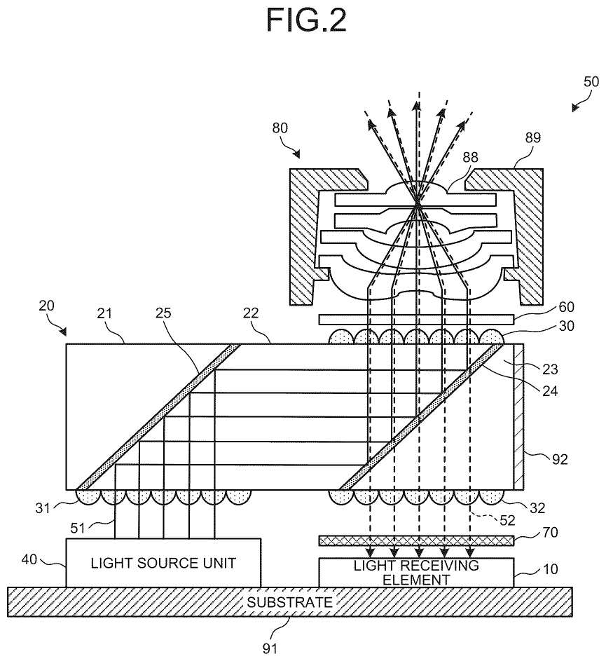

FIG. 2 is a view illustrating a configuration example of the optical device according to the first embodiment of the present disclosure. The drawing is a cross-sectional view illustrating a configuration example of the optical device 50. The configuration of the optical device 50 will be described with reference to the drawing. The optical device 50 in the drawing further includes the light projecting/receiving optical system 80, a polarization state changing portion 60, a third lens 32, a filter 70, and a light shielding film 92. Note that a solid arrow in the drawing indicates emission light 51 emitted from the light source unit 40. Furthermore, a broken line arrow in the drawing indicates reflected light 52.

The light projecting/receiving optical system 80 projects, onto the object, the emission light projected from the second lens 30 and receives reflected light from the object. The light projecting/receiving optical system 80 in the drawing represents an example including a lens barrel 89 and a plurality of lenses 88. By arranging the light projecting/receiving optical system 80, it is possible to perform ranging of a wide visual field area. Note that the plurality of lenses 88 is an example of a lens group described in claims.

The light guide portion 20 in the drawing includes prisms 21 to 23, a second branch portion 25, and a first branch portion 24.

The second branch portion 25 is formed on a joint surface of the prisms 21 and 22, and reflects the emission light. As illustrated in the drawing, the joint surface of the prisms 21 and 22 is formed at an angle of 45 degrees in an emission direction of the emission light. A reflection film arranged on the joint surface of the prisms 21 and 22 configures the second branch portion 25.

The first branch portion 24 is formed on the joint surface of the prisms 22 and 23, transmits one of the emission light and the reflected light, and reflects the other of the emission light and the reflected light. The first branch portion 24 in the drawing reflects, in a direction of the second lens 30, the emission light reflected by the second branch portion 25, and transmits the reflected light from the object in a direction of the light receiving element 10. The joint surface of the prisms 22 and 23 is formed at an angle of 45 degrees in the emission direction of the emission light. The first branch portion 24 is arranged on the joint surface of the prisms 22 and 23.

The first branch portion 24 can include, for example, a polarizing beam splitter (PBS). The polarizing beam splitter reflects S-polarized light and transmits P-polarized light. This polarizing beam splitter is used as the first branch portion 24, whereby S-polarized emission light in the emission light reflected by the second branch portion 25 is guided in the direction of the second lens 30. On the other hand, P-polarized emission light passes through the first branch portion 24 and is blocked by the light shielding film 92.

In the light guide portion 20 in the drawing, the emission light 51 is guided by being sequentially reflected by the second branch portion 25 and the first branch portion 24, and the reflected light 52 is guided by being transmitted through the first branch portion 24. The emission light 51 and the reflected light 52 passing through the light guide portion 20 are brought into substantially parallel light by the first lens 31 and the second lens 30.

The third lens 32 is an image forming lens, and is a lens that emits, to the light receiving element 10, the reflected light 52 emitted from the light guide portion 20. Note that an example in which each of the third lens 32, the second lens 30, and the first lens 31 in the drawing includes a microlens array is illustrated.

The polarization state changing portion 60 converts the emission light 51 from linearly polarized light into circularly polarized light, and converts the reflected light 52 from circularly polarized light into linearly polarized light. The polarization state changing portion 60 can include, for example, a quarter wave plate.

The filter 70 transmits the reflected light 52 having a predetermined wavelength in the reflected light 52. For example, a filter that transmits infrared light, such as a near-infrared light band-pass filter can be applied to the filter 70. The filter 70 can be arranged between the light guide portion 20 and the light receiving element 10. By arranging the filter 70, it is possible to remove unnecessary ambient light and the like.

A substrate 91 is a substrate on which the light source unit 40 and the light receiving element 10 are arranged. As illustrated in the drawing, the light source unit 40 and the light receiving element 10 are arranged adjacent to each other on the same plane of the substrate 91.

The light shielding film 92 is a film that blocks stray light from the light guide portion 20.

The emission light 51 emitted from the light source unit 40 is reflected by the second branch portion 25 of the light guide portion 20, and enters the first branch portion 24. An S-polarized light component of the emission light 51 is reflected again by the first branch portion 24, and enters the second lens 30. The emission light 51 emitted by the second lens 30 is changed to circularly polarized light by the polarization state changing portion 60, and is emitted through the light projecting/receiving optical system 80. Then, the reflected light 52 reflected by the object is emitted by the light projecting/receiving optical system 80, and enters the polarization state changing portion 60. The reflected light 52 is changed to P-polarized light by the polarization state changing portion 60. The P-polarized reflected light 52 is substantially collimated by the second lens 30, and enters the first branch portion 24 of the light guide portion 20. The P-polarized reflected light 52 is transmitted through the first branch portion 24 and guided in the direction of the light receiving element 10. The reflected light 52 from light guide portion 20 enters the light receiving element 10 through the third lens 32 and the filter 70. The light receiving element 10 generates two-dimensional distance information on the basis of the reflected light 52.

The S-polarized emission light reflected by the first branch portion 24 is changed to circularly polarized light by the polarization state changing portion 60, and is output from the optical device 50. The circularly-polarized emission light is emission light including substantially the same amount of linearly polarized light components of the P-polarized light and the S-polarized light. Thus, reflected light can be obtained even from an object having a surface with an extremely small reflectance of either the P-polarized light or the S-polarized light, and ranging can be performed.

In such a manner, the emission light from the light source unit 40 and the reflected light incident on the light receiving element 10 are guided in a parallel direction by the light guide portion 20. Thus, the light source unit 40 and the light receiving element 10 can be arranged adjacent to each other. For example, the light source unit 40 and the light receiving element 10 can be arranged adjacent to each other on the same substrate 91. In addition, since the emission light and the reflected light are split by the light guide portion 20, interference between optical paths thereof can be reduced. Furthermore, by arranging the light projecting/receiving optical system 80, and projecting the emission light and emitting the reflected light, it is possible to perform ranging of the wide visual field area. In addition, since the light projecting/receiving optical system 80 and the second lens 30 can be the common optical path of the emission light and the reflected light, it is possible to prevent generation of a visual field deviation of the emission light and the reflected light. It is possible to prevent positional displacement of a photographed image due to a change in distance.

In addition, by using the beam splitter as the first branch portion 24 of the light guide portion 20, parallax between the emission light and the reflected light can be made substantially 0. Thus, spot displacement on a surface of the light receiving element 10 due to the change in the measured distance can be prevented. In addition, since the emission light and the reflected light are brought into a substantially parallel light flux state by the arrangement of the second lens 30, the first lens 31, and the third lens 32 before and behind the light guide portion 20, a range of an incident angle to the first branch portion 24 can be narrowed down. Thus, it is possible to reduce the quantity of light at an incident angle outside the incident angle range in which the first branch portion 24 shows predetermined S-polarized light reflectance or more and predetermined P-polarized light transmittance or more. In addition, light can be guided in a direction orthogonal to the first branch portion 24 and the light receiving element 10. As a result, it is possible to prevent oblique incidence of the reflected light or the like, and it is possible to prevent a decrease in efficiency.

In addition, by using the polarizing beam splitter as the first branch portion 24, in a case where it is assumed that ratios of a P-polarized light component and an S-polarized light component of external ambient light are equal, the ambient light can be attenuated to 50% in which only the P-polarized light component is included. Thus, a noise component caused by the ambient light can be halved, and an S/N ratio can be improved. As a result, a ranging range can be widened.

Since the first lens 31 including a microlens array corresponding to light emission points (such as light emitting elements 41 or the like described later) of the light source unit 40 on a one-to-one basis is arranged immediately thereabove, a principal ray from each of the light emission points is emitted perpendicularly to a light source surface of the light source unit 40. A light source pitch of the light source unit 40 and a pitch of the first lens 31 can be made equal. In addition, the second lens 30 that is a microlens array corresponding to the lenses of the first lens 31 on a one-to-one basis is arranged. The second lens 30 is configured at a pitch equal to that of the first lens 31. In addition, the third lens 32 including a microlens array corresponding to the lenses of the second lens 30 on a one-to-one basis is further arranged. As a result, the pitches of the second lens 30 and the third lens 32 become equal. As a result, the emission points of the light source unit 40, the first lens 31, the second lens 30, the third lens 32, and the light receiving element 10 have the pitches and sizes on the one-to-one basis. Thus, a light source region and a light receiving region on the light receiving element can be made substantially equal in size.

Note that the configuration of the optical device 50 is not limited to this example. For example, the first lens 31, the second lens 30, and the third lens 32 can include members other than the microlens array. For example, the first lens 31 or the like can include a wafer level lens. By using the wafer level lens, a thinner and smaller lens can be manufactured at low cost.

In addition, the second lens 30 or the like may include an axis-shifted lens. The axis-shifted lens is a lens in which a principal ray (center light ray) of the emission light and the like from the light source unit 40 and an optical axis of the lens do not coincide with each other. By utilization of this axis-shifted lens, the light from the light source unit 40 can be refracted into substantially parallel light and brought into emission light having a principal ray at a predetermined angle with respect to the optical axis. In this case, the first lens 31 and the second lens 30 can be configured at different pitches. As a result, the light emitting region of the light source unit 40 and the light receiving region of the light receiving element 10 can be configured to have different sizes. By an adjustment of a magnification of the first lens 31 and the like, the light source unit 40 and the light receiving element 10 having different sizes can be used.

### Configuration of a Light Source Unit

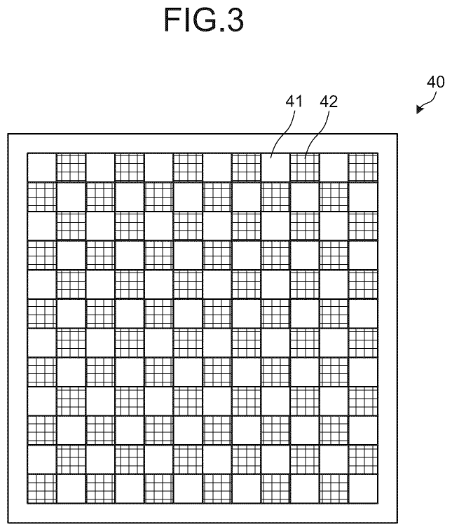

FIG. 3 is a view illustrating a configuration example of the light source unit according to the first embodiment of the present disclosure. The drawing is a plan view illustrating a configuration example of the light source unit 40. The light source unit 40 includes a plurality of light emitting elements 41 and 42 arranged two-dimensionally. The light emitting elements 41 and 42 can include, for example, a vertical cavity surface emitting laser (VCSEL).

Note that a photonic crystal laser can also be used as the light emitting elements 41 and the like. The photonic crystal laser is a surface emitting-type laser having an upper electrode, a lower electrode, and an active layer and a photonic crystal layer arranged between the upper electrode and the lower electrode. This photonic crystal laser is a laser that causes an optical wave generated by the active layer to resonate by a photonic crystal. This photonic crystal has an optical nanostructure having a two-dimensional refractive index distribution with a period similar to an oscillation wavelength. A lattice structure can be adopted as the optical nanostructure of the photonic crystal. This lattice structure corresponds to, for example, a structure having a plurality of holes arrayed in a two-dimensional lattice shape. A polarization direction of laser light can be changed by an adjustment of this lattice structure. For example, by changing the lattice structure (such as a shape or interval of holes) of the photonic crystal in the light emitting elements 41 and 42 described above, the polarization directions of the emission light from the light emitting elements 41 and 42 can be adjusted to different directions (orthogonal directions). That is, the light emitting elements 41 and 42 are formed in a common surface emitting-type laser, and have the photonic crystals having different lattice structures.

In addition, it is also possible to use a light emitting element in which polarization directions are aligned by an arrangement of a polarizing filter in a laser diode. For example, a polarization converter (PLC) or a polarizer in which a meta-surface technology is used can be applied to this polarizing filter. For example, a P-polarized light polarizing filter is arranged in each of the light emitting elements 41, and an S-polarized light polarizing filter is arranged in each of the light emitting elements 42. That is, the light emitting elements 41 and 42 have configurations in which the polarizing filters added to the laser diodes that are the light sources are different. As a result, it is possible to cause the light emitting elements 41 to emit the P-polarized light and the light emitting elements 42 to emit the S-polarized light. The light source unit 40 in the drawing represents an example in which the light emitting elements 41 and 42 are arranged in a checkered pattern.

Note that a case where the light emitting elements 41 and 42 are configured by one VCSEL is assumed in the drawing. On the other hand, a configuration in which sections having a plurality of VCSELs are arranged in a checkered pattern can also be applied to the light source unit 40. In this case, sections are divided into P-polarized light sections and S-polarized light sections.

As described above, the light source unit 40 is driven by the light source driving unit 2. The light source driving unit 2 can cause the light emitting elements 41 and 42 of the light source unit 40 to simultaneously emit light. Furthermore, the light source driving unit 2 can cause either one of the light emitting elements 41 or 42 to emit light. Note that the light emitting elements 41 are an example of a P-polarized light emitting unit described in claims. The light emitting elements 42 are an example of an S-polarized light emitting unit described in claims.

### Ranging Method

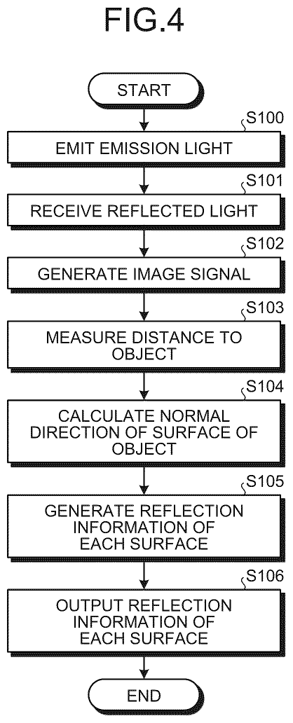

FIG. 4 is a view illustrating an example of the ranging method according to the first embodiment of the present disclosure. The drawing is a flowchart illustrating an example of the ranging method in the ranging device 1. First, the light source unit 40 emits emission light (Step S100). Then, the light receiving element 10 receives reflected light (Step S101), and generates an image signal (Step S102). Then, the image signal processing unit 4 measures a distance to an object (Step S103). At this time, the image signal processing unit 4 acquires a surface shape of the object from ranging information. Then, the image signal processing unit 4 calculates a normal direction of the surface of the object (Step S104). An incident angle to the object can be detected from the normal direction of the surface. Then, the image signal processing unit 4 generates reflection information for each surface of the object on the basis of the image signal (Step S105). Furthermore, in a case where reflectance of P-polarized light and S-polarized light of a substance is known information, it is possible to estimate a surface state of the substance. Then, the image signal processing unit 4 outputs the reflection information (Step S106).

### Another Configuration of an Optical Device

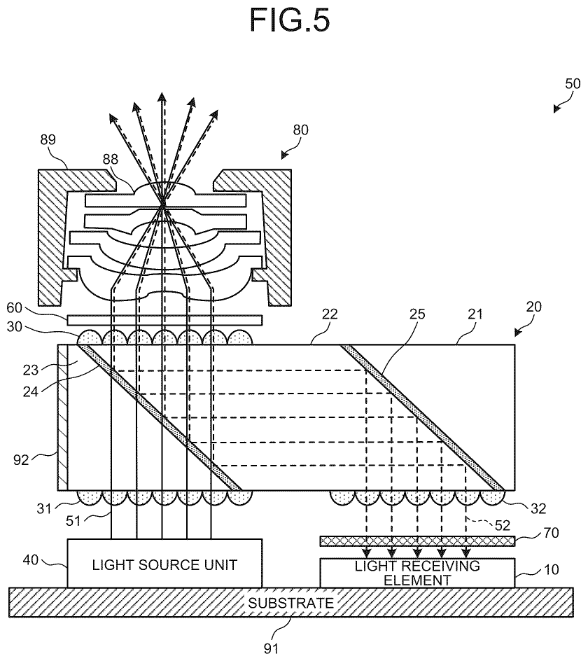

FIG. 5 is a view illustrating another configuration example of the optical device according to the first embodiment of the present disclosure. Similarly to FIG. 3, the drawing is a cross-sectional view illustrating a configuration example of an optical device 50. The optical device 50 in the drawing is different from the optical device 50 in FIG. 3 in a point that a light projecting/receiving optical system 80 and a second lens 30 are arranged immediately above a light source unit 40.

In a light guide portion 20 in the drawing, positions of a first branch portion 24 and a second branch portion 25 are different from those of the light guide portion 20 in FIG. 3. Emission light 51 from the light source unit 40 enters the first branch portion 24 through a first lens 31. P-polarized emission light in the incident emission light 51 is transmitted through the first branch portion 24 and emitted from the light guide portion 20. The emission light 51 is changed to circularly polarized light by a polarization state changing portion 60 and is projected onto an object. On the other hand, reflected light 52 is polarized into S-polarized light by the polarization state changing portion 60 and enters the first branch portion 24. The S-polarized reflected light is reflected by the first branch portion 24, reaches the second branch portion 25, is further reflected by the second branch portion 25, and enters a light receiving element 10.

In the light guide portion 20 in the drawing, the emission light is guided by being transmitted by the first branch portion 24, and the reflected light is guided by being sequentially reflected by the first branch portion 24 and the second branch portion 25. The emission light 51 and the reflected light 52 passing through the light guide portion 20 are brought into substantially parallel light by the first lens 31 and the second lens 30.

Note that the light guide portion 20 is arranged between the light projecting/receiving optical system 80 and a substrate 91 on which the light source unit 40 and the light receiving element 10 are mounted. In addition, the light guide portion 20 is arranged at a position overlapping with the light source unit 40 and the light receiving element 10 in a plan view in a vertical direction of the substrate 91. The light projecting/receiving optical system 80 is arranged at a position overlapping with either one of the light source unit 40 or the light receiving element 10 in a plan view in the vertical direction of the substrate 91. A surface of the light guide portion 20 which surface is close to the substrate 91 is defined as a first surface, and a surface on an opposite side of the first surface is defined as a second surface. It can also be understood that the light guide portion 20 guides the emission light from the light source unit 40 from the first surface to the second surface, and guides the incident light from the light projecting/receiving optical system 80 from the second surface to the first surface.

As described above, the optical device 50 of the first embodiment of the present disclosure includes the light guide portion 20 with which the emission light and the reflected light passing through the common optical system are made to branch and are guided in the parallel direction. As a result, the light source unit 40 that emits the emission light and the light receiving element 10 that receives the reflected light can be arranged adjacent to each other, and the optical device 50 can be downsized.

### 2. Second Embodiment

The optical device 50 of the first embodiment described above includes the light source unit 40 including the light emitting elements 41 and 42. On the other hand, an optical device 50 of the second embodiment of the present disclosure is different from that of the above-described first embodiment in a point that a light source unit 40 having a correction light source is included.

### Configuration of a Ranging Device

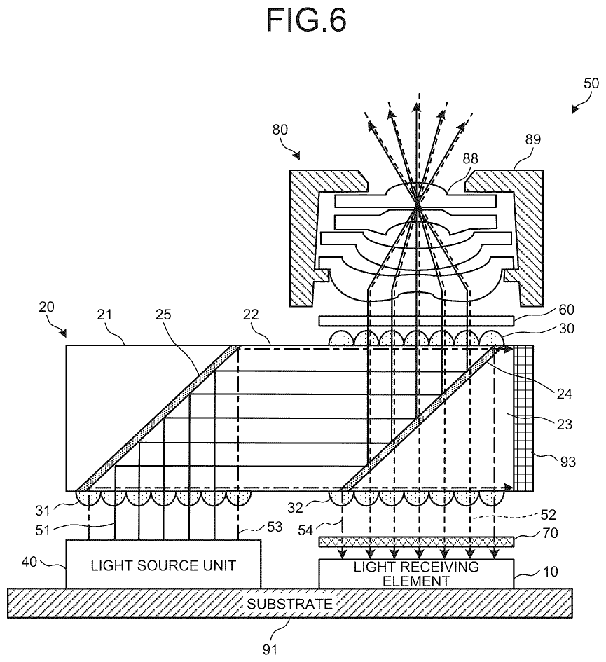

FIG. 6 is a view illustrating a configuration example of an optical device according to the second embodiment of the present disclosure. Similarly to FIG. 2, the drawing is a cross-sectional view illustrating a configuration example of the optical device 50. The optical device 50 in the drawing is different from the optical device 50 in FIG. 2 in a point of including the correction light source and further including a reflection film 93.

The light source unit 40 in the drawing includes the correction light source (light emitting element 43 described later). An arrow of an alternate long and short dash line in the drawing indicates reference light emitted from the correction light source. The reference light is emission light to detect displacement of prisms 21 to 23 included in the light guide portion 20.

The reflection film 93 reflects the reference light and converts a polarization state. The reference light emitted from the light source unit 40 is reflected by a second branch portion 25 and reaches a first branch portion 24. P-polarized reference light in the reference light is transmitted through the first branch portion 24 and reaches the reflection film 93. The reference light that reaches the reflection film 93 is converted into S-polarized light and reflected in a direction of the first branch portion 24. The reflected S-polarized reference light is reflected by the first branch portion 24 and enters a light receiving element 10, and reference light information is generated. The reference light information corresponds to, for example, an image generated on the basis of the reference light. The displacement of the prisms 21 to 23 can be detected on the basis of the reference light information. At the time of manufacture, the positional displacement can be corrected by an adjustment of the prisms 21 to 23 on the basis of the detected displacement. In addition, since the positional displacement of the prisms over time can also be detected from the reference light information, spot displacement of the emission light and the reflected light on the surface of the light receiving element 10 which displacement is generated after the manufacturing can also be corrected.

Note that the reference light can also be applied to a time adjustment in a distance measurement. Since the reference light propagates inside the optical device 50, time of flight of the reference light is constant. The time adjustment can be performed on the basis of the time of flight of the reference light.

### Configuration of a Light Source Unit

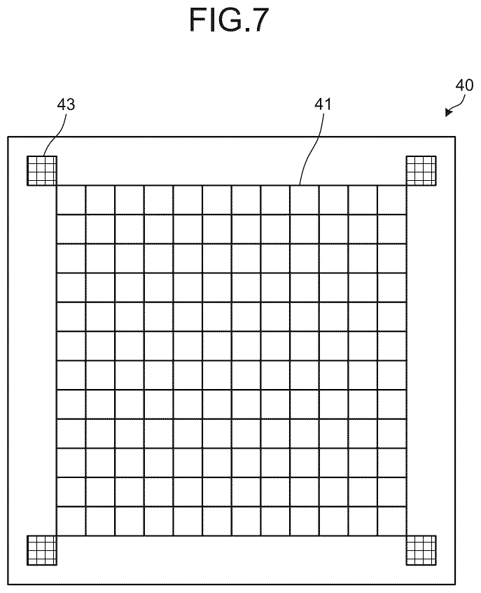

FIG. 7 is a view illustrating a configuration example of a light source unit according to the second embodiment of the present disclosure. The drawing is a plan view illustrating a configuration example of the light source unit 40. In the light source unit 40 in the drawing, the plurality of light emitting elements 41 is two-dimensionally arranged in a central portion, and the light emitting elements 43 are arranged in a peripheral portion. The light emitting elements 43 emit P-polarized light. The light emitting elements 43 are included in the above-described correction light source.

Since the configuration of the ranging device 1 other than this is similar to the configuration of the ranging device 1 in the first embodiment of the present disclosure, description thereof will be omitted.

As described above, the optical device 50 of the second embodiment of the present disclosure can correct the prisms 21 to 23 of the light guide portion 20 by the arrangement of the correction light source in the light source unit 40. In addition, the time adjustment in the distance measurement can also be performed by the emission light from the correction light source.

### 3. Third Embodiment

The optical device 50 of the above-described first embodiment includes the light projecting/receiving optical system 80. On the other hand, an optical device 50 of the third embodiment of the present disclosure is different from that of the above-described first embodiment in a point of further including an optical system of emission light.

### Configuration of a Ranging Device

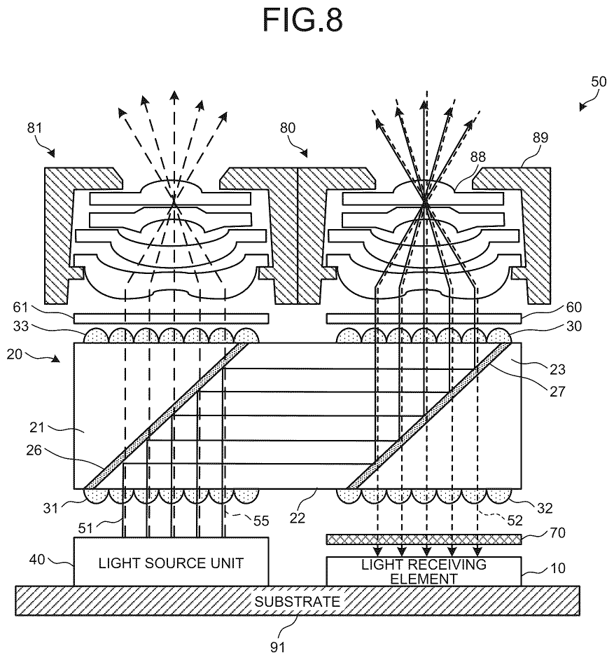

FIG. 8 is a view illustrating a configuration example of the optical device according to the third embodiment of the present disclosure. Similarly to FIG. 2, the drawing is a cross-sectional view illustrating a configuration example of the optical device 50. The optical device 50 in the drawing is different from the optical device 50 in FIG. 2 in a point of further including a light projecting optical system 81, a fourth lens 33, and a polarization state changing portion 61.

A light guide portion 20 in the drawing includes a third branch portion 26 and a fourth branch portion 27 instead of the second branch portion 25 and the first branch portion 24.

The third branch portion 26 is formed on a joint surface of prisms 21 and 22, and causes emission light to branch in a transmission direction and a reflection direction according to a polarization direction. Specifically, the third branch portion 26 transmits P-polarized emission light 51 and guides the P-polarized emission light in a direction of the fourth lens 33 and the light projecting optical system 81, and reflects the S-polarized emission light 51 in a direction of the fourth branch portion 27. Similarly to the first branch portion 24, the third branch portion 26 can include a polarizing beam splitter.

The fourth branch portion 27 is formed on a joint surface of the prisms 22 and 23, reflects emission light made to branch in the reflection direction by the third branch portion 26, and transmits the reflected light. Specifically, the fourth branch portion 27 reflects the S-polarized emission light 51 reflected by the third branch portion 26 and guides the S-polarized emission light in a direction of a second lens 30 and a light projecting/receiving optical system 80, and transmits P-polarized reflected light 52 and guides the P-polarized reflected light in a direction of a light receiving element 10. The fourth branch portion 27 can include a polarizing beam splitter.

The fourth lens 33 is an intermediate image lens, and emits the P-polarized emission light 51 transmitted through the third branch portion 26 of the light guide portion 20. The fourth lens 33 in the drawing can includes a microlens array similarly to the first lens 31.

The light projecting optical system 81 projects, onto an object, the emission light projected from the fourth lens 33. The light projecting optical system 81 in the drawing can include a lens barrel 89 and a plurality of lenses 88 similarly to the light projecting/receiving optical system 80.

The polarization state changing portion 61 changes the P-polarized emission light 51 transmitted through the third branch portion 26 of the light guide portion 20 to circularly-polarized emission light. Similarly to the polarization state changing portion 60, the polarization state changing portion 61 can include a quarter wave plate. At this time, turning directions of the polarization state changing portions 60 and 61 are made to coincide in either a clockwise direction or a counterclockwise direction. As a result, reflected light based on the emission light from the light projecting optical system 81 and reflected light based on the emission light from the light projecting/receiving optical system 80 can be changed to P-polarized light. Note that the polarization state changing portion 61 is an example of a second emission light polarization state changing portion described in claims. The polarization state changing portion 60 is an example of a reflected light polarization direction changing portion described in claims.

The optical device 50 in the drawing emits the P-polarized emission light 51 from the light projecting optical system 81 and the S-polarized emission light 51 from the light projecting/receiving optical system 80. By switching the emission light of the light source unit 40 between the P-polarized light and the S-polarized light, it is possible to select an optical system to perform the emission. For example, the light projecting optical system 81 can be configured to have a projection angle of view different from that of the light projecting/receiving optical system 80, and can be switched and used according to a size and distance of the object. As a result, ranging can be performed with optimum spatial resolution and a viewing angle.

In addition, in the optical device 50 in the drawing, in a case where the polarization state changing portions 60 and 61 are omitted, the P-polarized emission light and the S-polarized emission light can be switched and emitted. In this case, a surface state of the object can be detected by emission of the emission light in different polarization directions to the object. This application example will be described next.

### Ranging Method

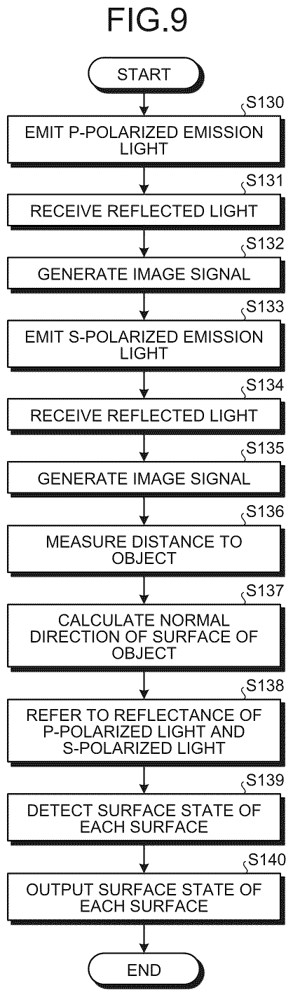

FIG. 9 is a view illustrating an example of a ranging method according to the third embodiment of the present disclosure. Similarly to FIG. 4, the drawing is a flowchart illustrating an example of the ranging method in the ranging device 1. First, the light source unit 40 emits P-polarized emission light (Step S130). Then, the light receiving element 10 receives reflected light (Step S131), and generates an image signal (Step S132). Then, the light source unit 40 emits S-polarized emission light (Step S133). Then, the light receiving element 10 receives reflected light (Step S134), and generates an image signal (Step S135). Then, the image signal processing unit 4 measures a distance to the object (Step S136). At this time, the image signal processing unit 4 measures the distance on the basis of the image signals generated in Step S132 and Step S135, and acquires a surface shape of the object. Then, the image signal processing unit 4 calculates a normal direction of the surface of the object (Step S137). Then, the image signal processing unit 4 refers to reflectance of each of the P-polarized light and the S-polarized light (Step S138). This can be performed by reading of the reflectance of each of the P-polarized light and the S-polarized light which reflectance is held in a storage unit 5. Then, the image signal processing unit 4 detects a surface state of each surface (Step S139) and performs an output thereof (Step S140).

Since the configuration of the optical device 50 other than the above is similar to the configuration of the optical device 50 in the first embodiment of the present disclosure, description thereof will be omitted.

In such a manner, the optical device 50 of the third embodiment of the present disclosure can emit the emission light in such a manner as to branch in two directions of the light projecting/receiving optical system 80 and the light projecting optical system 81. Thus, ranging can be performed by switching between the two optical systems.

### 4. Fourth Embodiment

In the optical device 50 of the third embodiment described above, the polarization state of the emission light is brought into the circular polarization by utilization of the polarization state changing portions 60 and 61 including the quarter wave plates. On the other hand, an optical device 50 of the fourth embodiment of the present disclosure is different from that of the above-described third embodiment in a point that a half wave plate is used to change a polarization state.

### Configuration of a Ranging Device

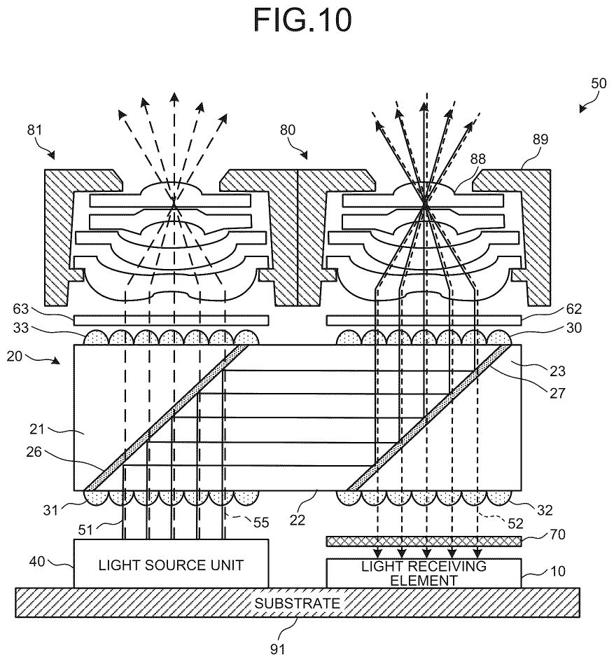

FIG. 10 is a view illustrating a configuration example of the optical device according to the fourth embodiment of the present disclosure. Similarly to FIG. 8, the drawing is a cross-sectional view illustrating a configuration example of the optical device 50. The optical device 50 in the drawing is different from the optical device 50 in FIG. 8 in a point of including a reflected light polarization direction changing portion 62 and an emission light polarization direction changing portion 63 instead of the polarization state changing portions 60 and 61.

The reflected light polarization direction changing portion 62 changes a polarization direction of the reflected light. Furthermore, the emission light polarization direction changing portion 63 changes a polarization direction of the emission light. Each of the reflected light polarization direction changing portion 62 and the emission light polarization direction changing portion 63 can include a half wave plate.

### Configuration of a Polarization Direction Changing Portion

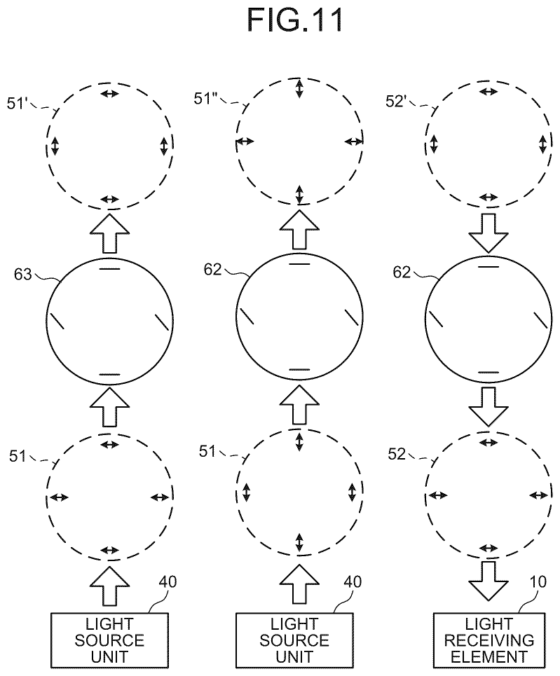

FIG. 11 is a view illustrating a configuration example of the emission light polarization direction changing portion and the reflected light polarization direction changing portion according to a fourth embodiment of the present disclosure. The drawing is a view illustrating the configuration example of the emission light polarization direction changing portion 63 and the reflected light polarization direction changing portion 62, and is a view for describing operation of the emission light polarization direction changing portion 63 and the reflected light polarization direction changing portion 62. Solid circles in the drawing represent the emission light polarization direction changing portion 63 and the reflected light polarization direction changing portion 62. Straight lines described in these circles represent directions of optical axes in the half wave plates. Furthermore, dotted circles in the drawing represent emission light 51 and reflected light 52. Arrows described in these circles represent the polarization directions.

P-polarized emission light 51 emitted from a light source unit 40 is changed to azimuth-polarized emission light 51′ by the emission light polarization direction changing portion 63. Furthermore, S-polarized emission light 51 emitted from the light source unit 40 is changed to radially-polarized emission light 51″ by the reflected light polarization direction changing portion 62. On the other hand, azimuth-polarized reflected light 52′ is polarized by the reflected light polarization direction changing portion 62 into P-polarized reflected light 52 and enters a light receiving element 10. In a case where a surface of an object has a shape like a wall facing the ranging device 1 and reflectance of the P-polarized light is larger than reflectance of the S-polarized light, the emission light is changed to azimuth-polarized light and emitted. As a result, since only the S-polarized reflected light can be obtained in all angle-of-view directions, a distance distance and ranging accuracy can be improved as an SN ratio, which is a ratio of a signal to noise, increases.

Since the configuration of the optical device 50 other than the above is similar to the configuration of the optical device 50 in the first embodiment of the present disclosure, description thereof will be omitted.

As described above, the optical device 50 of the fourth embodiment of the present disclosure can reduce an influence of the noise by emitting the emission light in which the polarization direction is changed.

### 5. Fifth Embodiment

In the optical device 50 of the above-described third embodiment, the light receiving element 10 images the reflected light. On the other hand, an optical device 50 of the fifth embodiment of the present disclosure is different from that of the above-described third embodiment in a point that a light receiving element 10 images visible light.

### Configuration of a Ranging Device

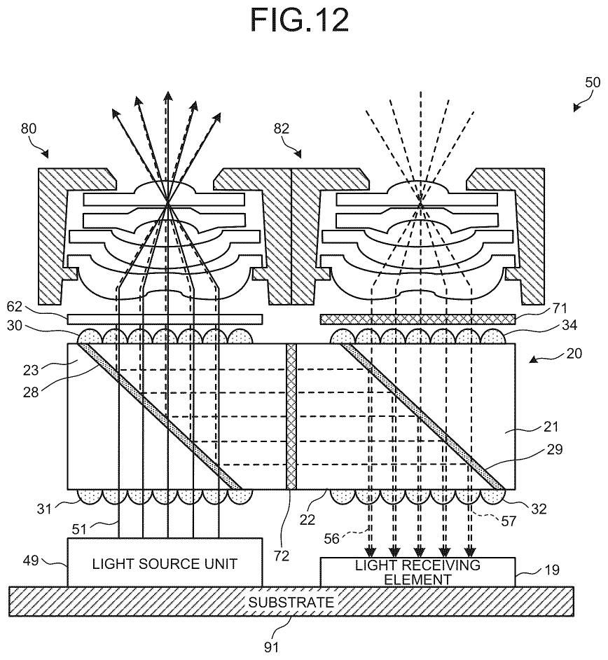

FIG. 12 is a view illustrating a configuration example of the optical device according to the fifth embodiment of the present disclosure. Similarly to FIG. 8, the drawing is a cross-sectional view illustrating a configuration example of the optical device 50. The optical device 50 in the drawing is different from the optical device 50 in FIG. 8 in a point of including a light receiving optical system 82, a fifth lens 34, and a visible light filter 71 instead of the light projecting optical system 81, the second lens 30, and the emission light polarization direction changing portion 63. Note that a light projecting/receiving optical system 80, a reflected light polarization direction changing portion 62, and a second lens 30 in the drawing are arranged immediately above a light source unit 49.

The light receiving optical system 82 emits incident light 57 to a focal position of the fifth lens 34. In addition, the fifth lens 34 is an intermediate image lens that emits the incident light 57. The fifth lens 34 in the drawing represents an example of emitting the incident light 57 as substantially parallel light.

The visible light filter 71 is a filter that transmits visible light. By the arrangement of the visible light filter 71, the visible light can be made to enter a light receiving element 19. For example, an infrared cut-off filter can be applied to the visible light filter 71.

A light guide portion 20 in the drawing includes a fifth branch portion 28, an infrared light filter 72, and a sixth branch portion 29. The fifth branch portion 28 causes emission light 51 to branch in a transmission direction and a reflection direction according to a polarization direction, and reflects reflected light 56 incident thereon. The infrared light filter 72 transmits infrared light in the reflected light 56 reflected by the fifth branch portion 28. A near-infrared light band-pass filter can be applied to the infrared light filter 72.

The sixth branch portion 29 multiplexes the incident light 57 incident thereon through the light receiving optical system 82 and the fifth lens 34 and the reflected light 56 transmitted through the infrared light filter 72, and causes the multiplexed light to enter the light receiving element 19. As the sixth branch portion 29, a dichroic mirror that transmits visible light and reflects infrared light can be used.

The light source unit 49 in the drawing is a light source unit that emits emission light of infrared light. P-polarized emission light in the emission light of the infrared light is transmitted through the fifth branch portion 28, and is projected onto an object through the second lens 30 and the light projecting/receiving optical system 80. Note that the second lens 30 and the light projecting/receiving optical system 80 are preferably optimized for infrared light.

The light receiving element 19 in the drawing receives the reflected light 56 of the infrared light passing through the light projecting/receiving optical system 80 and the second lens 30, and receives the incident light 57 of the visible light passing through the light receiving optical system 82 and the fifth lens 34. As the light receiving element 19, a light receiving element including a pixel that generates an image signal of the visible light and a pixel that generates an image signal of the infrared light can be used.

Since the configuration of the optical device 50 other than the above is similar to the configuration of the optical device 50 in the first embodiment of the present disclosure, description thereof will be omitted.

As described above, the optical device 50 of the fifth embodiment of the present disclosure can image the visible light.

### 6. Modification Example

The first lens 31 and the third lens 32 may be arranged in the light source unit 40 and the light receiving element 10 although being arranged in the light guide portion 20 in the optical device 50 of the first embodiment described above.

### Configuration of a Ranging Device

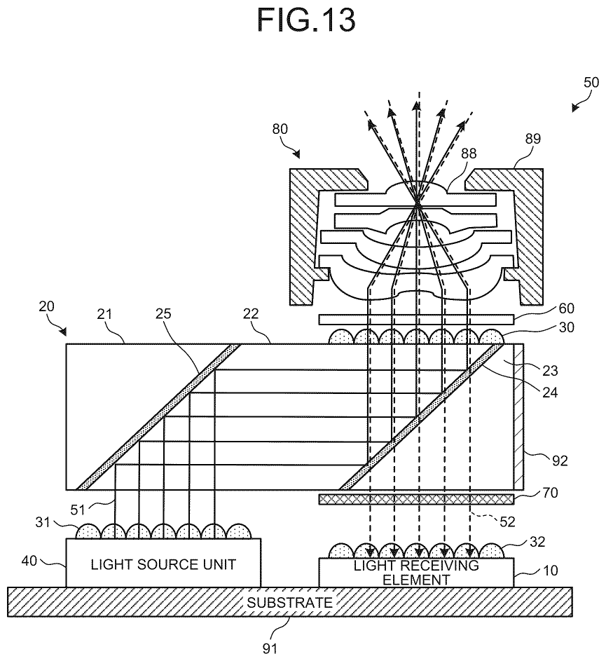

FIG. 13 is a view illustrating a configuration example of an optical device according to a modification example of an embodiment of the present disclosure. Similarly to FIG. 2, the drawing is a cross-sectional view illustrating a configuration example of an optical device 50. The optical device 50 in the drawing is different from the optical device 50 in FIG. 2 in a point that a first lens 31 is arranged in a light source unit 40 and a third lens 32 is arranged in a light receiving element 10.

Since the configuration of the optical device 50 other than the above is similar to the configuration of the optical device 50 in the first embodiment of the present disclosure, description thereof will be omitted.

In such a manner, in the optical device 50 according to the modification example of the embodiment of the present disclosure, the first lens 31 and the third lens 32 are arranged in the light source unit 40 and the light receiving element 10. The first lens 31 and the third lens 32 can be manufactured by a semiconductor process, and positional accuracy with respect to an optical axis can be improved.

### 7. Configuration Example of a Light Source Driving Unit and Light Source Unit

A light source driving unit and a light source unit applicable to the above-described optical device 50 will be described.

### Configuration of the Light Source Driving Unit

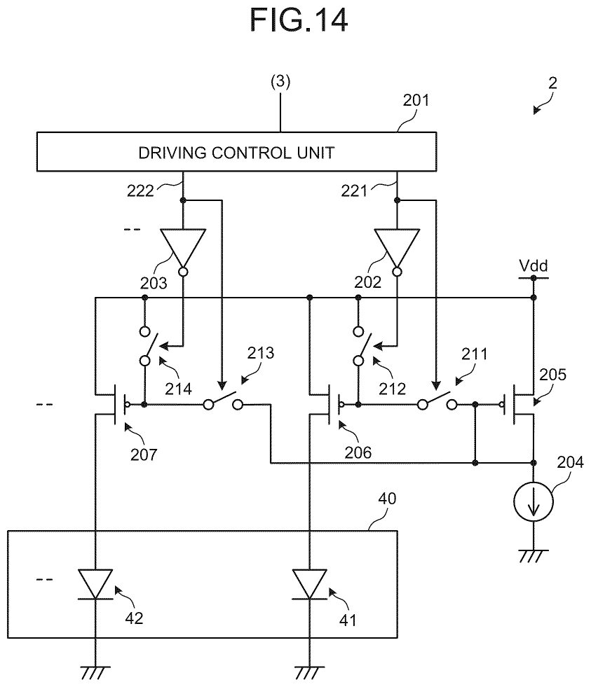

FIG. 14 is a view illustrating a configuration example of the light source driving unit according to the embodiment of the present disclosure. The drawing is a circuit diagram illustrating a configuration example of the light source driving unit 2. Note that a circuit of the light source unit 40 is also illustrated in the drawing. The light emitting elements 41 and 42 in the drawing are assumed to be VCSELs.

The light source driving unit 2 includes a driving control unit 201, NOT gates 202 and 203, a constant current circuit 204, MOS transistors 205 to 207, and switch elements 211 to 214. Note that p-channel MOS transistors can be used as the MOS transistors 205 to 207.

The driving control unit 201 generates a control signal for causing a light emission current to flow through the light emitting elements 41 and 42. The driving control unit 201 outputs the control signal through signal lines 221 and 222.

The MOS transistor 205 is a MOS transistor that causes a current of the constant current circuit 204 to flow as a reference current of a current mirror circuit.

The MOS transistor 206 is a MOS transistor that supplies the light emission current to the light emitting elements 41. The MOS transistor 206 is in current mirror connection with the MOS transistor 205. When the MOS transistor 206 becomes conductive, a current corresponding to the reference current of the MOS transistor 206 included in the current mirror circuit flows and is supplied to the light emitting elements 41.

The MOS transistor 207 is a MOS transistor that supplies the light emission current to the light emitting elements 41. Similarly to the MOS transistor 206, the MOS transistor 207 is in current mirror connection with the MOS transistor 205, and a current corresponding to the reference current of the MOS transistor 205 flows at the time of conduction. This current is supplied to the light emitting elements 42.

The switch elements 211 and 212 are elements that apply a driving signal to a gate of the MOS transistor 206. The control signal of the signal line 221 is input to a control input of the switch element 212 through the NOT gate 202. In addition, the control signal of the signal line 221 is input in series to a control input of the switch element 211. These switch elements 211 and 212 become conductive exclusively, and the MOS transistor 206 becomes conductive when the switch element 211 becomes conductive. The same applies to the switch elements 213 and 214.

Note that the circuits of the MOS transistors 206 and 207 in the drawing are arranged for each of the light emitting elements 41 and 42 of the light source unit 40.

The driving control unit 201 generates the control signal on the basis of the control of the control unit 3 in FIG. 1, and outputs the control signal to the signal lines 221 and 222. The driving control unit 201 can perform control of causing the light emitting elements 41 and 42 to simultaneously emit light. Furthermore, the driving control unit 201 can also perform control of causing either one of the light emitting elements 41 or 42 to emit light.

Note that the configuration of the light source driving unit 2 is not limited to this example. For example, the switch elements 212 and 214 and the NOT gates 202 and 203 can be omitted.

### Configuration of the Light Source Unit

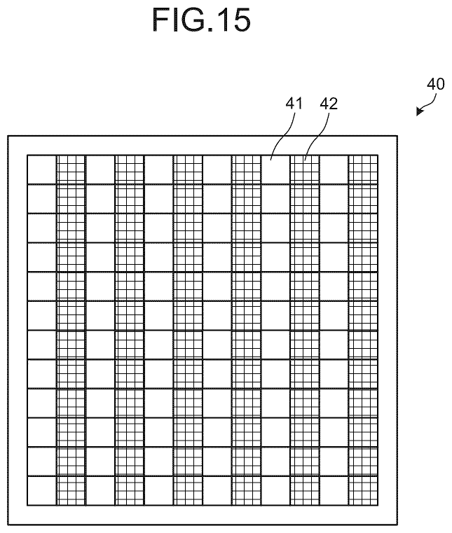

FIG. 15 is a view illustrating a configuration example of a light source unit according to an embodiment of the present disclosure. The drawing is a view illustrating a modification example of the light source unit 40. A light source unit 40 in the drawing represents an example in which light emitting elements 41 and 42 are arranged in columns in a vertical direction in the drawing and the columns of the light emitting elements 41 and 42 are alternately arranged.

### 8. Configuration Example of a Light Receiving Element

The above-described light receiving element 10 will be described.

### Configuration of the Light Receiving Element

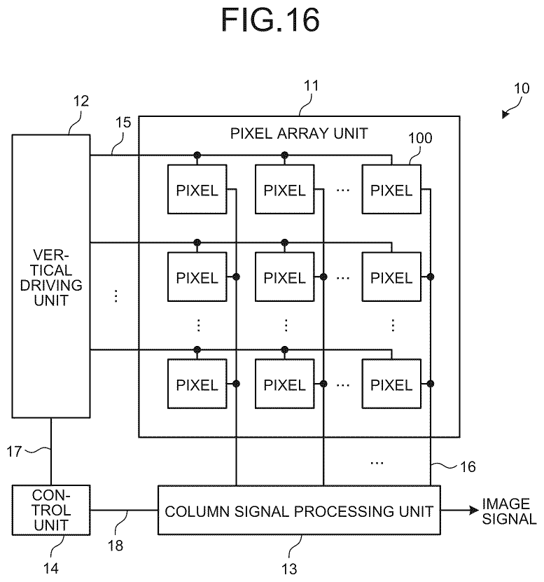

FIG. 16 is a block diagram illustrating a configuration example of the light receiving element 10. The light receiving element 10 is a semiconductor element that generates image data of an object. The light receiving element 10 includes a pixel array unit 11, a vertical driving unit 12, a column signal processing unit 13, and a control unit 14.

The pixel array unit 11 includes an arrangement of a plurality of pixels 100. The pixel array unit 11 in the drawing represents an example in which the plurality of pixels 100 is arrayed in a shape of a two-dimensional matrix. Here, each of the pixels 100 includes a photoelectric conversion unit that performs photoelectric conversion of incident light, and generates an image signal of an object on the basis of the emitted incident light. For example, a photodiode can be used as the photoelectric conversion unit. Signal lines 15 and 16 are wired to each of the pixels 100. Each of the pixels 100 generates the image signal by being controlled by a control signal transmitted by the signal line 15, and outputs the generated image signal through the signal line 16. Note that the signal line 15 is arranged for each row of the shape of the two-dimensional matrix, and is commonly wired to the plurality of pixels 100 arranged in one row. The signal line 16 is arranged for each column of the shape of the two-dimensional matrix, and is commonly wired to the plurality of pixels 100 arranged in one column.

The vertical driving unit 12 generates the control signal of the pixels 100 described above. The vertical driving unit 12 in the drawing generates the control signal for each row of the two-dimensional matrix of the pixel array unit 11 and serially performs an output thereof through the signal line 15.

The column signal processing unit 13 processes the image signals generated by the pixels 100. The column signal processing unit 13 in the drawing simultaneously performs processing of the image signals from the plurality of pixels 100 arranged in one row of the pixel array unit 11, the image signals being transmitted through the signal line 16. As this processing, for example, analog-digital conversion of converting analog image signals generated by the pixels 100 into digital image signals, and correlated double sampling (CDS) of removing offset errors of the image signals can be performed. The processed image signals are output to a circuit or the like outside the light receiving element 10.

The control unit 14 controls the vertical driving unit 12 and the column signal processing unit 13. The control unit 14 in the drawing generates control signals to control the vertical driving unit 12 and the column signal processing unit 13 on the basis of data that is input from an external circuit or the like and that instructs a clock, an operation mode, and the like. Then, the control unit 14 outputs the control signals respectively through signal lines 17 and 18, and controls the vertical driving unit 12 and the column signal processing unit 13.

The control unit 14 in the drawing controls each unit of the light receiving element 10 on the basis of the control of the control unit 3 in FIG. 1. In addition, the image signals output from the column signal processing unit 13 in the drawing are input to the image signal processing unit 4 in FIG. 1.

Note that the effects described in the present description are merely examples and are not limitations, and there may be a different effect.

Note that the present technology can also have the following configurations.
(1)

An optical device comprising:
a light source unit that emits emission light;
a first lens that emits the emission light;
a second lens that projects the emission light, which is emitted by the first lens, onto an object and emits reflected light obtained by reflection of the projected emission light on the object;
a light receiving element that receives the reflected light emitted by the second lens; and
a light guide portion that guides and emits the reflected light, which is emitted by the second lens, to the light receiving element while guiding, to the second lens, the emission light emitted by the first lens, wherein
the light guide portion emits the reflected light in a direction substantially parallel to the emission light emitted by the first lens.
(2)

The optical device according to according to the above (1), wherein
the light guide portion includes a first branch portion that transmits one of the emission light and the reflected light and reflects other of the emission light and the reflected light, and a second branch portion that reflects the other of the emission light and the reflected light.
(3)

The optical device according to according to the above (2), wherein
the light guide portion guides the emission light by sequential reflection thereof on the second branch portion and the first branch portion, and guides the reflected light by transmission thereof through the first branch portion.
(4)

The optical device according to according to the above (2), wherein
the light guide portion guides the emission light by transmission thereof through the first branch portion, and guides the reflected light by sequential reflection thereof on the first branch portion and the second branch portion.
(5)

The optical device according to according to the above (2), wherein
the light source unit emits the emission light having linearly polarized light components orthogonal to each other, and
the light guide portion includes the first branch portion that transmits one of the linearly polarized light components of the emission light and the reflected light and reflects the linearly polarized light component in another direction of the emission light and the reflected light.
(6)

The optical device according to according to the above (5), further comprising
a polarization state changing portion that converts the emission light from the light guide portion from linearly polarized light into circularly polarized light, and converts the reflected light from circularly polarized light into linearly polarized light.
(7)

The optical device according to according to any one of the above (1) to (6), further comprising
a third lens that emits the reflected light emitted from the light guide portion, wherein
the light receiving element receives the reflected light emitted by the third lens.
(8)

The optical device according to according to any one of the above (1) to (7), further comprising
a light projecting/receiving optical system that projects, onto the object, the emission light projected from the second lens and emits the reflected light from the object.
(9)

The optical device according to according to any one of the above (1) to (8), further comprising
a filter that transmits the reflected light of a predetermined wavelength in the reflected light emitted from the light guide portion.
(10)

The optical device according to any one of (1) to (9), in which
the light guide portion includes a third branch portion, which causes the emission light to branch in a transmission direction and a reflection direction according to a polarization direction, and a fourth branch portion, which reflects the emission light caused to branch in the reflection direction by the third branch portion and transmits the reflected light, and projects the emission light transmitted through the third branch portion onto the object.
(11)

The optical device according to (10), further including
a fourth lens that emits the emission light transmitted through the third branch portion.
(12)

The optical device according to (11), further including
a light projecting optical system that projects the emission light emitted by the fourth lens onto the object.
(13)

The optical device according to (10), further including
an emission light polarization state changing portion that converts the emission light transmitted through the third branch portion from linearly polarized light into circularly polarized light, and
a reflected light polarization state changing portion that converts the reflected light from circularly polarized light into linearly polarized light.
(14)

The optical device according to (10), further including
a second emission light polarization state changing portion that changes a polarization direction of the emission light transmitted through the third branch portion, and
a reflected light polarization direction changing portion that changes a polarization direction of the reflected light.
(15)

The optical device according to any one of the above (1) to (9), wherein
the light source unit emits infrared light as the emission light, and
the light guide portion includes a fifth branch portion that causes the emission light to branch in a transmission direction and a reflection direction according to a polarization direction and that reflects the reflected light incident thereon, an infrared light filter that transmits infrared light in the reflected light reflected by the fifth branch portion, and a sixth branch portion that multiplexes incident light incident thereon and the reflected light transmitted through the infrared light filter and that causes the multiplexed light to enter the light receiving element.
(16)

The optical device according to the above (15), further comprising
a fifth lens that emits the incident light.
(17)

The optical device according to the above (16), further comprising
a light receiving optical system that emits the incident light to the fifth lens.
(18)

The optical device according to the above (15), further comprising
a visible light filter that transmits visible light in the reflected light that enters the sixth branch portion.
(19)

The optical device according to any one of the above (1) to (18), wherein
the light source unit includes a P-polarized light emission unit that emits the emission light of a P-polarized component, and an S-polarized light emission unit that emits the emission light of an S-polarized component.
(20)

The optical device according to any one of the above (1) to (19), further comprising
a substrate on which the light source unit and the light receiving element are arranged adjacent to each other.
(21)

The optical device according to any one of the above (1) to (20), wherein
the first lens emits the emission light as substantially parallel light, and
the second lens emits the reflected light as substantially parallel light.
(22)

An optical device comprising:
a substrate;
a light source unit that is arranged on the substrate and emits emission light;
a light receiving unit arranged adjacent to the light source unit on the substrate and including a semiconductor substrate having a photodiode;
a light guide portion that is arranged in such a manner as to overlap with the light source unit and the light receiving unit in a plan view, and has a first surface close to the substrate and a second surface on an opposite side of the first surface;
a lens group arranged in such a manner as to overlap with either one of the light source unit or the light receiving unit in a plan view; and
a lens barrel that supports the lens group, wherein
the light guide portion guides the emission light from the first surface to the second surface, and guides incident light from the lens group from the second surface to the first surface.
(23)

The optical device according to the above (22), further comprising a first lens that is arranged between the light source unit and the light guide portion and transmits the emission light.
(24)

The optical device according to the above (23), wherein the light guide portion includes a beam splitter.
(25)

A ranging device comprising:
a light source unit that emits emission light;
a first lens that emits the emission light;
a second lens that projects the emission light, which is emitted by the first lens, onto an object and emits reflected light obtained by reflection of the projected emission light on the object;
a light receiving element that receives the reflected light emitted by the second lens;
a light guide portion that guides and emits the reflected light, which is emitted by the second lens, to the light receiving element while guiding, to the second lens, the emission light emitted by the first lens; and
a ranging unit that measures a distance to the object on a basis of an image signal generated by the light receiving element on a basis of the reflected light, wherein
the light guide portion emits the reflected light in a direction substantially parallel to the emission light emitted by the first lens.

### REFERENCE SIGNS LIST

1 RANGING DEVICE
2 LIGHT SOURCE DRIVING UNIT
4 IMAGE SIGNAL PROCESSING UNIT
10, 19 LIGHT RECEIVING ELEMENT
20 LIGHT GUIDE PORTION
24 FIRST BRANCH PORTION
25 SECOND BRANCH PORTION
26 THIRD BRANCH PORTION
27 FOURTH BRANCH PORTION
28 FIFTH BRANCH PORTION
29 SIXTH BRANCH PORTION
30 SECOND LENS
31 FIRST LENS
32 THIRD LENS
33 FOURTH LENS
34 FIFTH LENS
40 LIGHT SOURCE UNIT
41 to 43 LIGHT EMITTING ELEMENT
50 OPTICAL DEVICE
60, 61 POLARIZATION STATE CHANGING PORTION
62 REFLECTED LIGHT POLARIZATION DIRECTION CHANGING PORTION
63 EMISSION LIGHT POLARIZATION DIRECTION CHANGING PORTION
70 FILTER
71 VISIBLE LIGHT FILTER
72 INFRARED LIGHT FILTER
80 LIGHT PROJECTING/RECEIVING OPTICAL SYSTEM
81 LIGHT PROJECTING OPTICAL SYSTEM
82 LIGHT RECEIVING OPTICAL SYSTEM
88 LENS
89 LENS BARREL
91 SUBSTRATE
100 PIXEL

What is claimed is:

1. An optical device, comprising:
a light source unit that emits emission light;
a first lens that emits the emission light;
a second lens that projects the emission light, which is emitted by the first lens, onto an object and emits reflected light obtained by reflection of the projected emission light on the object;
a light receiving element that receives the reflected light emitted by the second lens; and
a light guide portion that guides and emits the reflected light, which is emitted by the second lens, to the light receiving element while guiding, to the second lens, the emission light emitted by the first lens, wherein
the light guide portion emits the reflected light in a direction substantially parallel to the emission light emitted by the first lens.

2. The optical device according to claim 1, wherein
the light guide portion includes a first branch portion that transmits one of the emission light and the reflected light and reflects other of the emission light and the reflected light, and a second branch portion that reflects the other of the emission light and the reflected light.

3. The optical device according to claim 2, wherein
the light guide portion guides the emission light by sequential reflection thereof on the second branch portion and the first branch portion, and guides the reflected light by transmission thereof through the first branch portion.

4. The optical device according to claim 2, wherein
the light guide portion guides the emission light by transmission thereof through the first branch portion, and guides the reflected light by sequential reflection thereof on the first branch portion and the second branch portion.

5. The optical device according to claim 2, wherein
the light source unit emits the emission light having linearly polarized light components orthogonal to each other, and
the light guide portion includes the first branch portion that transmits one of the linearly polarized light components of the emission light and the reflected light and reflects the linearly polarized light component in another direction of the emission light and the reflected light.

6. The optical device according to claim 5, further comprising
a polarization state changing portion that converts the emission light from the light guide portion from linearly polarized light into circularly polarized light, and converts the reflected light from circularly polarized light into linearly polarized light.

7. The optical device according to claim 1, further comprising
a third lens that emits the reflected light emitted from the light guide portion, wherein
the light receiving element receives the reflected light emitted by the third lens.

8. The optical device according to claim 1, further comprising
a light projecting/receiving optical system that projects, onto the object, the emission light projected from the second lens and emits the reflected light from the object.

9. The optical device according to claim 1, further comprising
a filter that transmits the reflected light of a predetermined wavelength in the reflected light emitted from the light guide portion.

10. The optical device according to claim 1, wherein
the light source unit emits infrared light as the emission light, and
the light guide portion includes a fifth branch portion that causes the emission light to branch in a transmission direction and a reflection direction according to a polarization direction and that reflects the reflected light incident thereon, an infrared light filter that transmits infrared light in the reflected light reflected by the fifth branch portion, and a sixth branch portion that multiplexes incident light incident thereon and the reflected light transmitted through the infrared light filter and that causes the multiplexed light to enter the light receiving element.

11. The optical device according to claim 10, further comprising
a fifth lens that emits the incident light.

12. The optical device according to claim 11, further comprising
a light receiving optical system that emits the incident light to the fifth lens.

13. The optical device according to claim 10, further comprising
a visible light filter that transmits visible light in the reflected light that enters the sixth branch portion.

14. The optical device according to claim 1, wherein
the light source unit includes a P-polarized light emission unit that emits the emission light of a P-polarized component, and an S-polarized light emission unit that emits the emission light of an S-polarized component.

15. The optical device according to claim 1, further comprising
a substrate on which the light source unit and the light receiving element are arranged adjacent to each other.

16. The optical device according to claim 1, wherein
the first lens emits the emission light as substantially parallel light, and
the second lens emits the reflected light as substantially parallel light.

17. An optical device, comprising:
a substrate;
a light source unit that is arranged on the substrate and emits emission light;
a light receiving unit arranged adjacent to the light source unit on the substrate and including a semiconductor substrate having a photodiode;
a light guide portion that is arranged in such a manner as to overlap with the light source unit and the light receiving unit in a plan view, and has a first surface close to the substrate and a second surface on an opposite side of the first surface;
a lens group arranged in such a manner as to overlap with either one of the light source unit or the light receiving unit in a plan view; and
a lens barrel that supports the lens group, wherein
the light guide portion guides the emission light from the first surface to the second surface, and guides incident light from the lens group from the second surface to the first surface.

18. The optical device according to claim 17, further comprising a first lens that is arranged between the light source unit and the light guide portion and transmits the emission light.

19. The optical device according to claim 17, wherein the light guide portion includes a beam splitter.

20. A ranging device, comprising:
a light source unit that emits emission light;
a first lens that emits the emission light;
a second lens that projects the emission light, which is emitted by the first lens, onto an object and emits reflected light obtained by reflection of the projected emission light on the object;
a light receiving element that receives the reflected light emitted by the second lens;
a light guide portion that guides and emits the reflected light, which is emitted by the second lens, to the light receiving element while guiding, to the second lens, the emission light emitted by the first lens; and
a ranging unit that measures a distance to the object on a basis of an image signal generated by the light receiving element on a basis of the reflected light, wherein
the light guide portion emits the reflected light in a direction substantially parallel to the emission light emitted by the first lens.
